(19) United States
(12) Patent Application Publication
(10) Pub. No.: US 2005/0180557 A1
(43) Pub. Date: Aug. 18, 2005

(54) Echo canceller for removing speaker to microphone feedback on a personal computer

(76) Inventor: William Edmond Norton III, San Diego, CA (US)

Correspondence Address: William E. Norton III;Apartment 167, 15367 Maturin Drive, San Diego, CA, 92127, US

(21) Appl. No.: 11/057,517

(22) Filed: Feb. 14, 2005

Related U.S. Application Data
(60) Provisional application No. 60/545,212, filed on Feb. 18, 2004.

(51) Int. Cl. H04M 9/08

(52) U.S. Cl. 379/406.1

(57) ABSTRACT

An echo cancellation chip and supporting circuitry receiving inputs from a personal computer's speakers and microphone and outputting a filtered signal which contains the microphone signal, but with any signals acoustically coupled from the speaker circuit substantially reduced. The apparatus is designed to be 1.) external to the PC and serially cabled between the PC and its speaker and microphone, 2.) as a sub-circuit incorporated on the PC's sound card, or 3.) internal to the PC as a circuit on the PC's motherboard. The echo cancellations occur independently of the personal computers operations, though the circuit may have multiple modes which can be set by the system.

### BACKGROUND OF THE INVENTION

### Description of Related Art

Many devices exist for personal computer voice communications. Speakerphones for personal computers are widespread. There are also software products that will allow users to transmit and receive voice data to other users. However, these devices and software products are limited in their functionality, by either relying on traditional speakerphones or telephony devices built into the computer and connected over analog telephone lines, or, in the case of multi-point Internet voice connections, using half-duplex controls, which require that a system mute its speakers before transmitting its microphone signal. This meant that PCs were limited to traditional speakerphone performance, and that true multiplex situations of many people talking and listening at the same time were not possible.

Existing systems must deal with the acoustic echo from the speakers to the microphone to prevent one talker from hearing himself because the remote end's microphone picked up the transmission and retransmitted it. They either deal with it by shutting down one channel when the other is active, or they attempt to perform the communications with a speakerphone device internal to the computer and connected over an analog line. The analog line is an additional source of echo, and the speakerphone is not capable of multipoint communications past what a conference call can do. A system which tries to handle the feedback through system software will perform poorly.

This patent application describes a hardware solution for the problem of dealing with the echo loops occurring in full-duplex multi-point communications. The problem of echo cancellation is greatly simplified by placing an echo canceller directly between speaker and microphone. The cancellation occurs without requiring resources from the operating system. This allows PCs to use data transmission circuits to transmit voice signals to each other through the separate transmit and receive channels that digital communications schemes possess without engaging in complex echo cancellation calculations or incurring analog line limitations.

### SUMMARY OF THE INVENTION

In view of the limitations now present in the prior art, the present invention provides a new and useful personal-computer hardware which improves full duplex communication which is simpler in construction, more universally usable and more versatile in operation than known apparatus of this kind.

The purpose of the present invention is to provide a new personal computer communications device that has improved performance not offered by the prior art apparatus that result in a new voice communications device which is not apparent, obvious, or suggested, either directly or indirectly by any of the prior art apparatus

This present invention generally comprises an echo cancellation device that has inputs from the personal computer's speaker channels and microphone. This cancellation provides the PC's communication system any acoustic echo cancellation requirements for applications which would permit audio communications between networked computers and computers connected to the Internet. It allows personal computers to send their microphone input signals to each other for playback through the PC speakers without the risk of feedback loops forming. This hardware allows personal computers to transmit and receive audio signals without feedback impairment from acoustic echo, complicated software echo mitigation or from 2-to-4 wire hybrid echoes that traditional analog telecommunications lines suffer.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is a block diagram of the circuit for decoupling speaker-to-microphone feedback, showing signal connections between echo canceller speakers, microphone, and PC sound system according to the present invention.

FIG. 2. is a front view of the echo canceller device connected to a personal computer according to the present invention, implemented externally.

FIG. 3. is an echo canceller on the motherboard of a personal computer or on a sound card according to the present invention, implemented as a part of the sound circuitry.

### DETAILED DESCRIPTION OF THE INVENTION

Referring now descriptively to the drawings, the attached figures illustrate an echo canceller for removing speaker-to-microphone feedback on a personal computer.

The present invention generally comprises a circuit with an echo canceller chip or chipset and connections to a personal computer's sound inputs and outputs and its speakers and microphone.

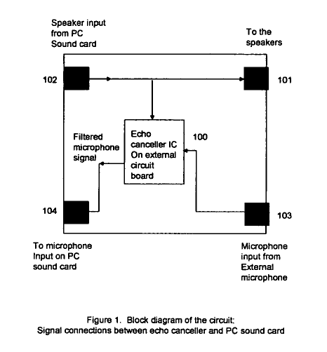

FIG. 1 illustrates the topology of the circuit according to the present invention The echo-canceller circuit (100) samples the speaker outputs of the personal computer (101), and passes the energy of the signal on to the speaker jacks (102). The microphone input (103) goes into the echo-canceller chipset, and the chipset calculates a signal (104) which contains the microphone signal with any components which correlate to the speaker outposts removed. This filtered signal contains the local speaker's voice without the remote speaker's voice. The filtered signal goes into the PC microphone input for transmission.

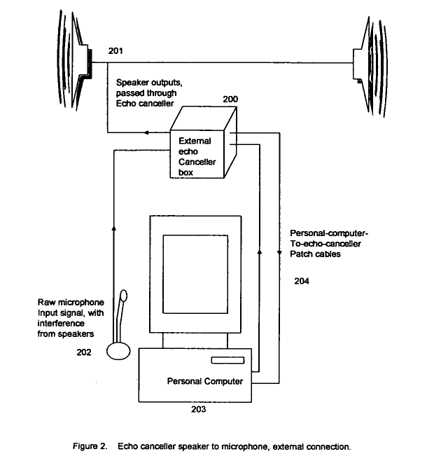

FIG. 2 illustrates an embodiment of operation of the present invention in which the echo canceller (200) exists outside the personal computer as an external peripheral device. The device (200) is inserted between the personal computer (203) and the speakers (201) and the microphone (202) using a set of patch cables (204). The speakers (201) and microphone (202) are connected to the echo canceller (200) using the cables normally used to connect the speakers (201) and microphone (202) to the PC (203)

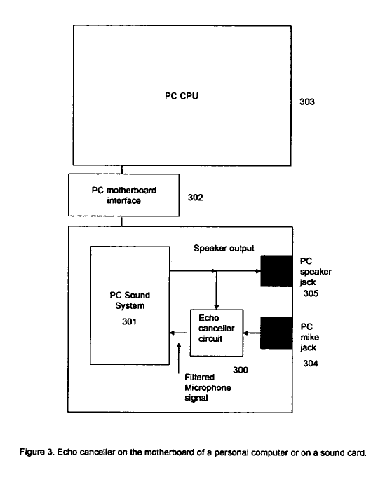

FIG. 3 illustrates an embodiment of operations of the present invention in which the echo canceller (300) is incorporated in the existing sound card or motherboard internally to the personal computer. The echo canceller (300) is inserted between the PC sound system (301) and the PC speaker jacks (305) and microphone (304). The interface between the soundcard circuitry (302) may be a bus system for the PC motherboard (303) for a removable card, or a connection to the IO of the motherboard (303) for an onboard sound system.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

1. I claim that I have invented the device of connecting a hardware echo canceller between the speakers and microphone of a personal computer for the purpose of allowing multipoint concurrent voice transmissions. The value of this device it that it will greatly improve the use of the PC in voice communications by removing echo cancellation demands from the operating system software. I claim that there are many topologies which will achieve this benefit, and that all of them fall under the definition of this device.
